(19) United States
(12) Patent Application Publication
(10) Pub. No.: US 2002/0143670 A1
(43) Pub. Date: Oct. 3, 2002

(54) Techniques for providing elecronic delivery orders and order tracking

(76) Inventors: John Cushing, Lake Forest, CA (US); Eric Silver, Kirkland, WA (US); Michael A. Schwank, Bainbridge Island, WA (US)

Correspondence Address: MCDERMOTT, WILL & EMERY, 18191 VON KARMAN AVE., SUITE 500, IRVINE, CA, 92612-7108, US

(21) Appl. No.: 10/092,439

(22) Filed: Mar. 8, 2002

Related U.S. Application Data
(60) Provisional application No. 60/273,973, filed on Mar. 8, 2001.

(51) Int. Cl. G06F 17/60

(52) U.S. Cl. 705/28; 705/7

(57) ABSTRACT

The present invention is a system for scheduling a delivery and for providing delivery status notification which includes the steps of accessing a scheduling and notification database, inputting delivery data into the scheduling and notification database relating to an item to be delivered, collecting, delivery data into a delivery order, transmitting the delivery order relating to the item to be delivered together with a delivery request, receiving an acceptance or a decline of the delivery request, and providing notification of either acceptance or a decline of the delivery request

This application claims priority of U.S. Provisional Patent Application No. 60/273,973, filed Mar. 8, 2001.

### BACKGROUND OF THE INVENTION

1. Field of the Invention

The present invention relates to a Web-based or integrated electronic delivery-scheduling and notification system which receives input data regarding an item, cargo, container, etc. to be delivered and which provides electronic notification, such as e-mail, that an item, cargo, container, etc., has been accepted for delivery and/or has been delivered. More particularly, the present invention receives data, from a customs broker or the like, regarding an item for delivery (hereinafter “cargo”), which has cleared customs and which is awaiting pickup at a terminal or airport by a trucking company or the like hereinafter referred to as “trucking company”) for delivery to a consignee who is expecting to receive the goods. The customs broker inputs data into various windows-based data input fields of the web-based electronic delivery ordering system so as to notify a trucking company that the cargo is awaiting pickup at a terminal or airport. In addition to the above features, the electronic delivery system 1) notifies the terminal of the trucking company's name and the cargo which is to be picked up, 2) the shipper that a trucking company will pick up or has delivered the cargo all without any additional input by the customs broker, and 3) additional notifications are sent to various participants in the transportation of the cargo once the cargo has cleared customs, has been tendered to a nominated trucking company, picked up for delivery and/or has been delivered to the consignee.

2. Description of the Related Art

Conventionally, scheduling cargo for delivery after it has been cleared by customs requires a customs broker to contact a trucking company/rail line by telephone and/or facsimile and/or messenger to request a pickup of the cargo for delivery to a specific location or consignee (recipient of the cargo).

As shown in FIG. 1, the customs broker, after receiving a customs clearance number for a specific piece of cargo that resides at a seaport or airport, contacts by telephone, facsimile or messenger, the shipper advising that the cargo has cleared customs, the consignee to advise that the cargo has cleared customs and that delivery will be made shortly. Typically, the customs broker will contact a trucking company or the like by both telephone and/or facsimile so as to provide a delivery order regarding the cargo. The delivery order usually includes information regarding the shipper, the location to where the cargo will be delivered, the type of cargo, any marks and/or numbers, where the cargo currently resides, a bill of lading, a customs number as well as any comments regarding the type of equipment which may be required to pick up the cargo.

After receiving the delivery order, the trucking company will either accept or decline the job. Assuming the trucking company accepts the job, the acceptance is relayed back to the customs broker by telephone or facsimile. Upon receiving information that the trucking company has accepted the job, the customs broker contacts the seaport/airport providing the terminal with the delivery order and the bill of lading as well with the name of the trucking company that will pick up the cargo. The customs broker also forwards the name of the trucking company to the shipper and consignee. In addition, the customs broker may forward information to the cargo carrier, steamship line, airline or the like providing the trucking company information. This information will be used by the cargo carrier, steamship line or airline for insurance release purposes. Once the trucking company has picked up the cargo at the seaport/airport, the seaport/airport can make this information available to the customs broker that the cargo has left the gate.

To this end, as shown in FIG. 1, the customs broker, after receiving clearance by customs, sends a request for pickup of the cargo to a trucking company. The pertinent information sent to the trucking company will be a delivery order, which advises the trucking company of the cargo to be picked up. The delivery order also includes location for the pickup, location for delivery and cargo type, as well as any identifying marks on the cargo such as container number or other markings. Once the trucking company receives the delivery order by facsimile or by messenger, the trucking company will contact the customs broker and will either accept or decline the delivery order.

Assuming that the delivery order has been accepted by the trucking company, the customs broker will forward to the seaport/airport, where the cargo resides, a delivery order which includes the name of the trucking company that will be picking up the cargo. Traditionally, the information sent to the seaport/airport will be by facsimiled document or a document sent by messenger. The delivery order usually includes information that the cargo has cleared customs together with a signed original of the delivery order.

Because the customs broker must contact each of the parties individually by phone, facsimile and/or messenger, the system becomes very inefficient and time consuming. Moreover, the conventional system tends to break down in communications if the trucking company fails to return calls or facsimile documents are misplaced or discarded. Moreover, the conventional system of transmitting information either by facsimile or messenger raises issues of security since the information regarding cargo can be intercepted by individuals who can use that information to seize the cargo before it is either picked up at the terminal or delivered to the consignee.

### SUMMARY OF THE INVENTION

The present invention addresses the deficiencies in the conventional system of scheduling pickup and delivery of cargo from a terminal or the like by providing a more efficient system which automates requests for pickup with time limit acceptance by the trucking company and which provides electronic notification to all concerned parties such as the trucking company, seaport/airport, shipper, cargo carrier and consignee that an item, cargo or container has cleared customs, has been accepted for pickup, has left the seaport/airport and has been delivered. In addition, the present invention provides a more secure system for transmitting information regarding cargo since access to either the Web-based system or integrated system can only be provided by verification of an authorized user. In this fashion, information regarding cargo cannot be intercepted by unauthorized individuals.

According to one aspect of the present invention, the invention is a method for scheduling a delivery and for providing delivery status notification. The method includes the steps of accessing a scheduling and notification database, inputting delivery data into the scheduling and notification database relating to an item to be delivered, collecting delivery data into a delivery order, transmitting the delivery order relating to the item to be delivered together with a delivery request, receiving an acceptance or a decline of the delivery request, and providing notification of either acceptance or a decline of the delivery request.

According to another aspect of the present invention, the invention is a delivery schedule and notification system which includes input device for inputting data relating to an item to be delivered and delivery information, collecting device for collecting and storing input data relating to the delivery of the item, and transmitting device for transmitting the collected input data so as to schedule delivery of the item.

These and other features and advantages according to the present invention will be more readily understood by referring to the following detailed description of the preferred embodiment taken in conjunction with the attached drawings.

### BRIEF DESCRIPTION OF THE DRAWINGS

FIG. 1 is a block diagram of a conventional method of scheduling delivery and pickup of cargo;

FIG. 2 is a block diagram of the present invention showing an automated delivery scheduling and notification system;

FIG. 3 is a perspective view showing the outward appearance of the eDO system according to the invention;

FIG. 4 is a block diagram of the eDO system in either an integrated system or Web-based system;

FIG. 5 is a flow diagram describing how an end-user accesses the eDO system of the present invention;

FIG. 6 is a flow diagram describing how a customs broker enters pertinent information regarding cargo, shipper, consignee and recipients of electronic notifications;

FIGS. 7A-7D depict graphical user interfaces for inputting information regarding cargo, shipper and consignee;

FIG. 8 is a graphical user interface for inputting recipient information;

FIG. 9 is a flow diagram describing how bill of lading information and cargo information are input and how delivery order information is collected and approved by the customs broker;

FIG. 10 is a graphical user interface user for inputting bills of lading information;

FIG. 11 is a graphical user interface used for inputting information regarding cargo;

FIG. 12A is a graphical user interface showing a delivery order prepared for approval by the customs broker and

FIG. 12B is a graphical user interface showing that the delivery order has been approved;

FIG. 13 is a graphical user interface of an approved delivery order;

FIG. 14A and FIG. 14B are graphical user interfaces depicting how a customs broker checks the status of a delivery order from the customs broker's home page;

FIG. 15 is a flow diagram describing how a trucking company reviews delivery orders and utilizes the eDO system of the present invention to provide notification to participants in the transportation of cargo;

FIGS. 16A and 16B are graphical user interfaces describing how a trucking company accesses delivery orders from its home page on the eDO system;

FIG. 17 is a graphical user interface of a trucking company's version of a delivery order;

FIG. 18 is a graphical user interface of a cargo information page;

FIG. 19 is a graphical user interface which displays a list of accepted cargo and its status and history;

FIG. 20 is a graphical user interface which provides proof of delivery of cargo;

FIG. 21 is a flow diagram describing how a terminal/cargo carrier reviews delivery orders, status and history;

FIG. 22 is a flow diagram describing how a terminal providing notification to the eDO system for electronic notification distribution that cargo has been picked up for deliver; and

FIG. 23 is a graphical user interface of a terminal/cargo carrier's home page which provides access to the eDO system.

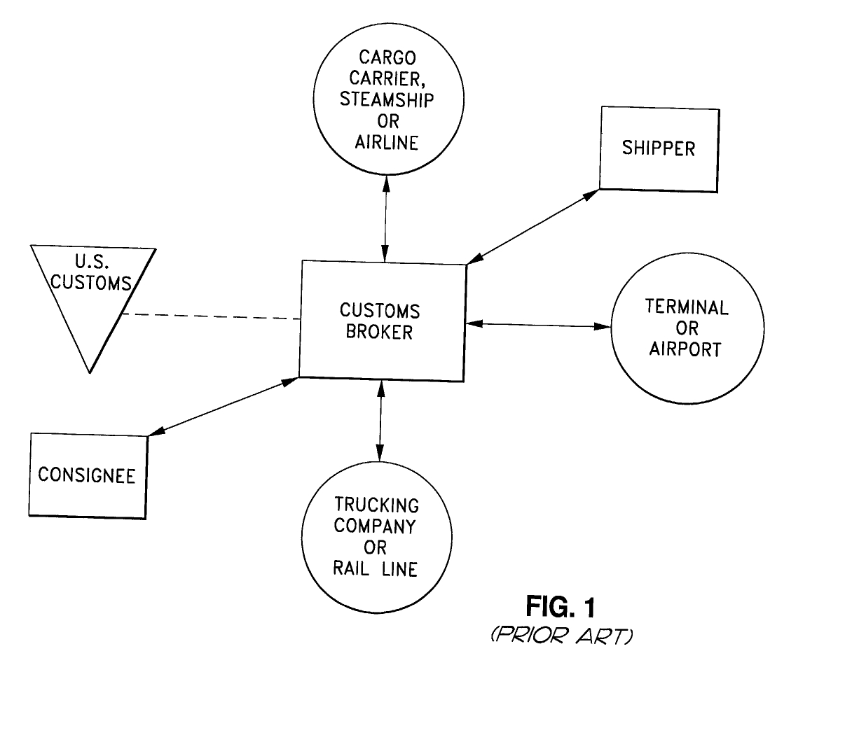

### DETAILED DESCRIPTION OF THE PREFERRED EMBODIMENT

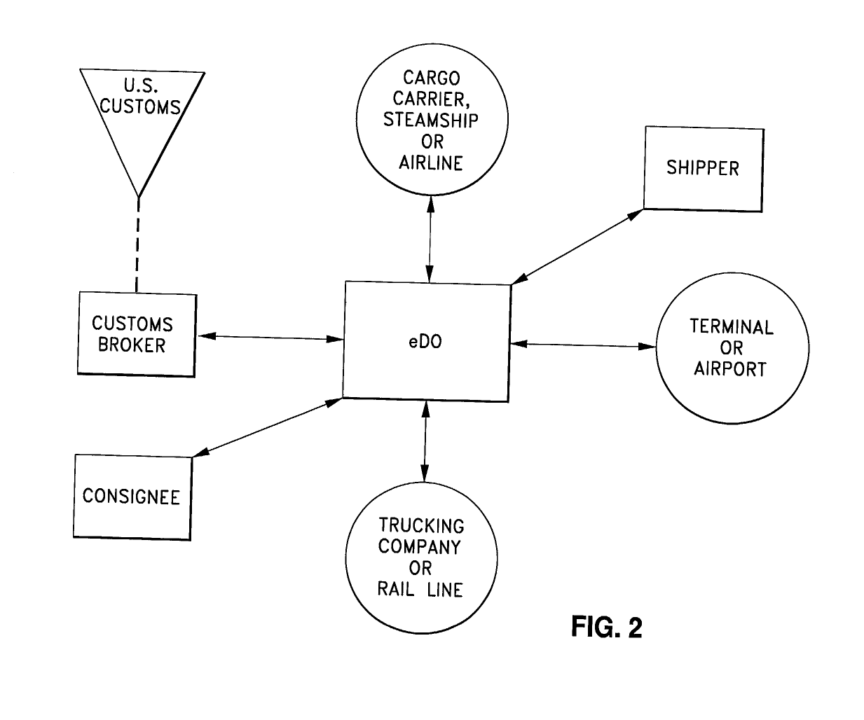

As shown in the block diagram in FIG. 2, the present invention can be either a Web-based system or a system that is integrated with an end user's personal computer or networked server, for example, the system could be directly integrated with the customs broker's server in which only the customs broker has access to input data into the system regarding specific cargo which has cleared customs. Whereas, in the Web-based system, the automated delivery and notification system is open to all that pay for the electronic delivery order service.

In the preferred embodiment, the customs broker signs onto the Web-based electronic delivery order system (hereinafter “eDO system”) and enters/or has entered automatically pertinent cargo information into data fields of a windows-based graphical-user interface. The pertinent cargo information identifies the cargo as well as delivery order information to be sent to participants in the transportation chain. As shown in the block diagram of FIG. 2, the eDO system automatically transmits the pertinent information regarding the cargo to the trucking company/rail line, seaport/airport, cargo carrier, such as a steamship line or airline, shipper and consignee, all without the customs broker's involvement after entering the pertinent cargo and participant information. In this regard, the eDO system transmits the delivery order information to each of the participants at predetermined timings, for example, the eDO system transmits notification to the seaport/airport that a specific trucking company will be picking up cargo only after a trucking company has accepted the job to pick up a specific piece of cargo at the seaport/airport. The system of delivery scheduling and automated notification will be explained in greater detail below.

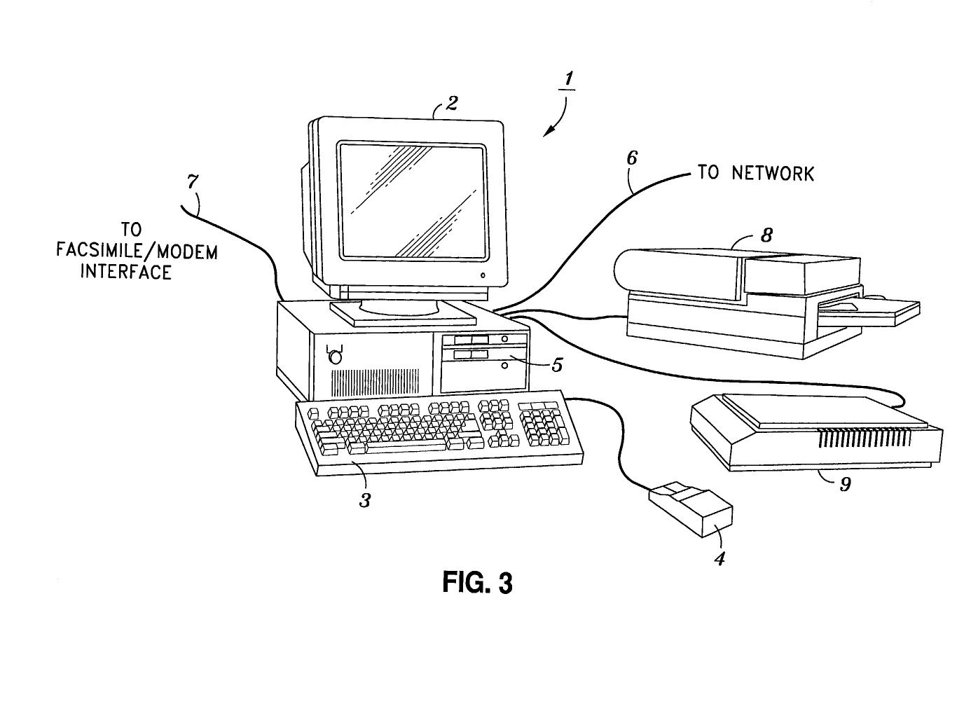

FIG. 3 is a view showing the outward appearance of a representative embodiment of the invention. Shown in FIG. 3 is computing equipment 1 such as a Macintosh for an IBM PC, PC compatible computer or server having a windowing environment, such as Microsoft Windows. Provided with computing equipment server 1 is display screen 2, such as a color monitor or a monochromatic monitor, keyboard 3 for entering text data and user commands, and a pointing device such as a mouse 4 for pointing and manipulating objects displayed on display 2. Computing equipment/server 1 also includes a mass storage device such as disk drive 5. Data can be input into computing equipment 1 from a variety of sources such as a network interface 6 or from external devices via facsimile/modem interface 7. Network interface 6 is used to connect computing equipment 1 to a local area network (LAN) or to a wide area network (WAN) such as the World Wide Web (hereinafter “the Web”). Computing equipment/server 1 can also be directly connected to printer 8 and scanner 9.

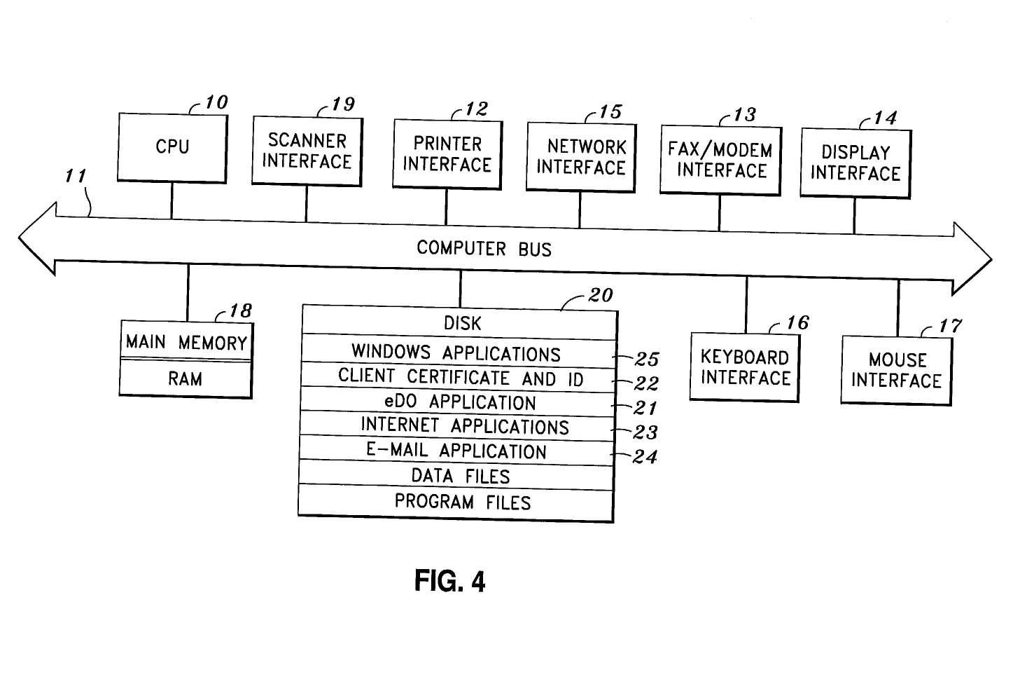

FIG. 4 is a detailed block diagram showing the internal construction of computing equipment/server 1. As shown in FIG. 4, computing equipment/server 1 includes central processing unit (CPU) 10 interfaced with computer bus 11. Also interfaced with computer bus 11 is printer interface 12, fax modem interface 13, display interface 14, network interface 15, keyboard interface 16, mouse interface 17, main memory 18, scanner interface 19 and disk drive 20.

Main memory 18 interfaces with computer bus 11 so as to provide random access memory storage for use by CPU 10 when executing a software application, such as eDO software application 21 stored in disk drive 20. More specifically, CPU 10 loads these software applications into disk drive 20 into main memory 18 and executes the software applications out of main memory 18. In accordance with user instructions, stored software applications are activated which permit processing and manipulation of data. Typically, software applications stored on disk drive 20, such as eDO software application 21, client certificate and ID authorization software 22, internet applications 23, e-mail applications 24 and windows applications 25 have been stored in disk drive 20 by downloading the software applications from a computer readable medium such as floppy disk, CDROM or by downloading the software applications directly from the Web.

Disk drive 20 stores data files which can include text files and image files, in compressed or uncompressed format, and stores software application files such as those noted above. The software application files include windows applications 25, client certificate and ID authorization software 22, eDO application software 21, Internet/Web applications 23, e-mail application software 24, data files and program files.

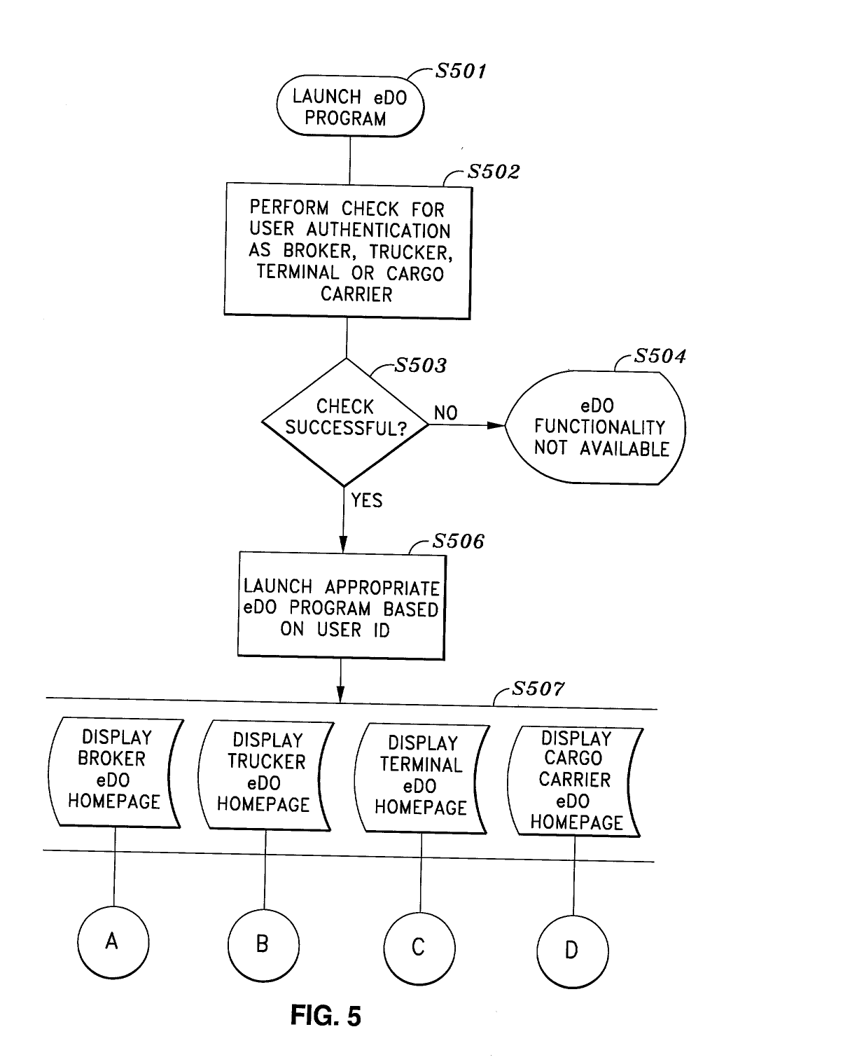

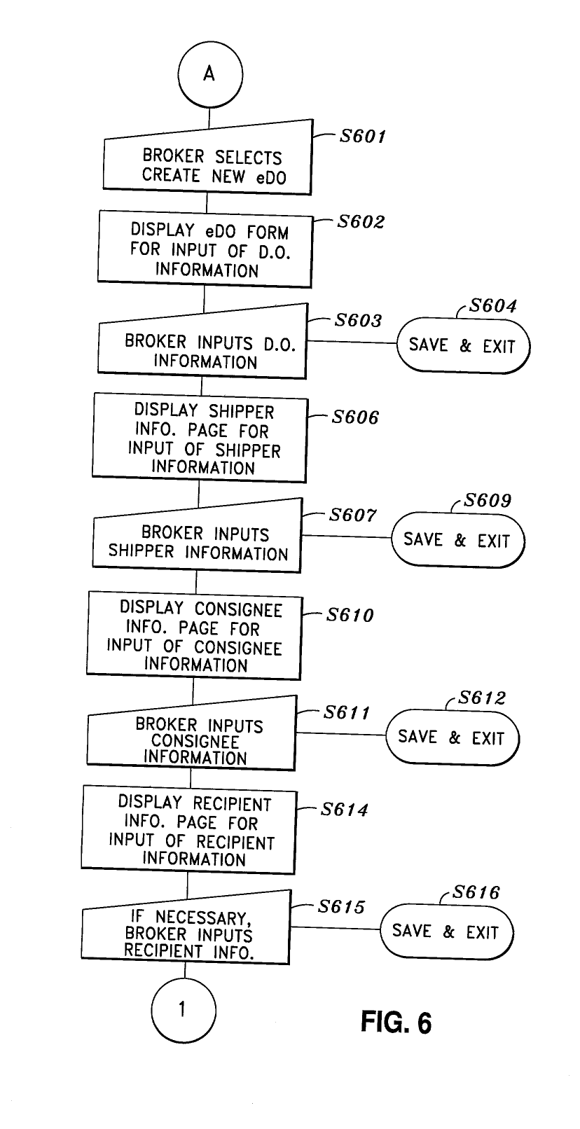

A detailed description of how the eDO system of the present invention will now be explained with respect to the flow diagrams illustrated in FIGS. 5 and 6.

FIGS. 5 and 6 are flow diagrams describing the operation of the electronic delivery order system (eDO system) in more detail. FIG. 5 describes a preferred embodiment of the eDO system from a Web-based perspective. Although many different end users may access the eDO system, for the purposes of describing the preferred embodiment, a description will be provided relating to a customs broker's access to the Web-based eDO system via the customs broker's personal computing (PC) system or server.

In step S501 of FIG. 5, the customs broker (hereinafter referred to as “broker”) launches the eDO program application at the broker's PC or server, which interfaces with Internet/Web-based applications 23 so as to obtain access to the Web on which the eDO system resides. In this regard, the eDO system can reside at a remote server which is linked to the Internet/Web. In step S502, upon accessing the eDO system via the Web, the eDO system prompts the broker's PC system for its access certification, which includes ID, passwords, etc., in order to provide access to the eDO system and to authenticate the user as a broker, trucker, terminal or cargo carrier. In step S503, if the check is unsuccessful, the eDO functionality will not be available to the user and the eDO system signs off in step S504. However, if the check is successful, flow proceeds to step S506 and, based on the user's certification, an appropriate eDO program will be launched for the user and data will be retrieved from the eDO system's data storage for access by the user.

In step S507, the eDO system will transmit via the Web an appropriate home page for the intended user. In step S507, the eDO system can display a broker's home page, a trucker's home page, a terminal's home page or a cargo carrier's home page depending on the certification check and user's ID (a cargo carrier can be a steamship line, an airline or the like). A description of each home page and functionality provided therein will be described below.

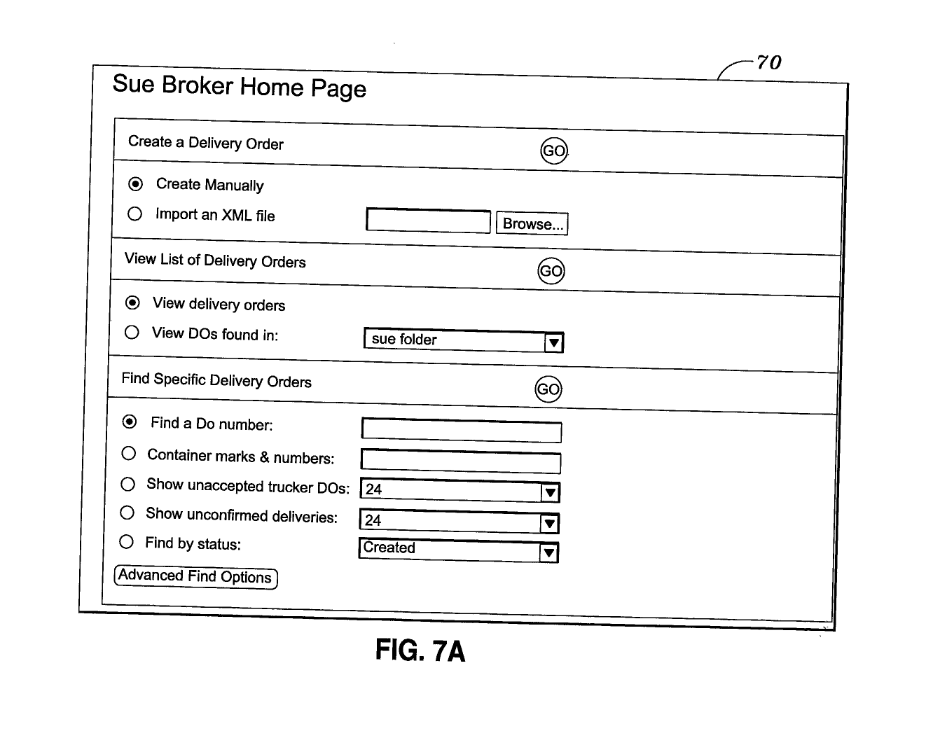

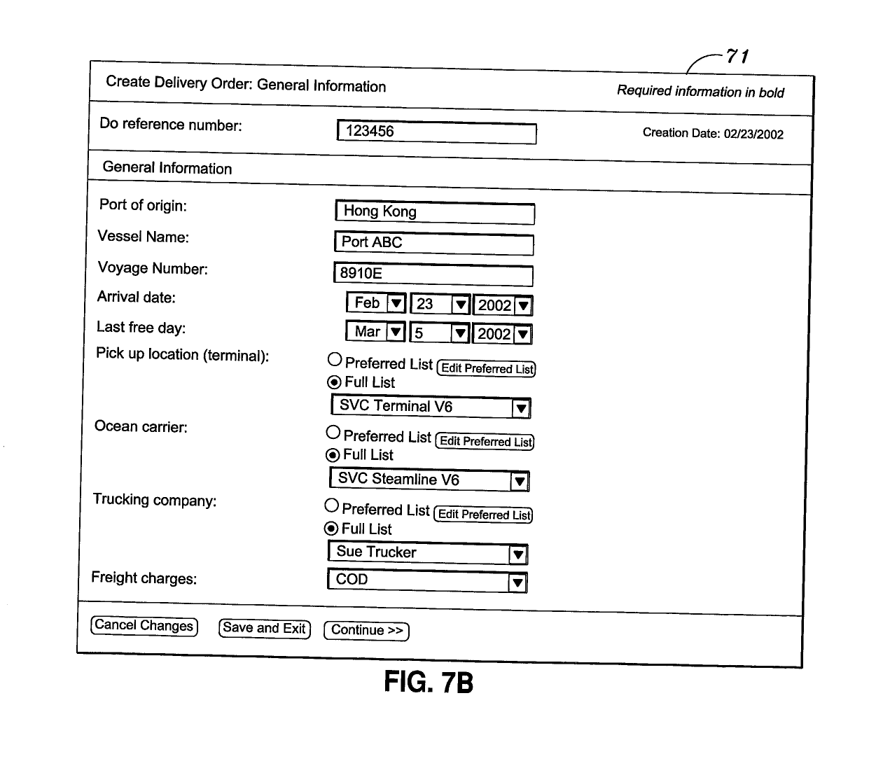

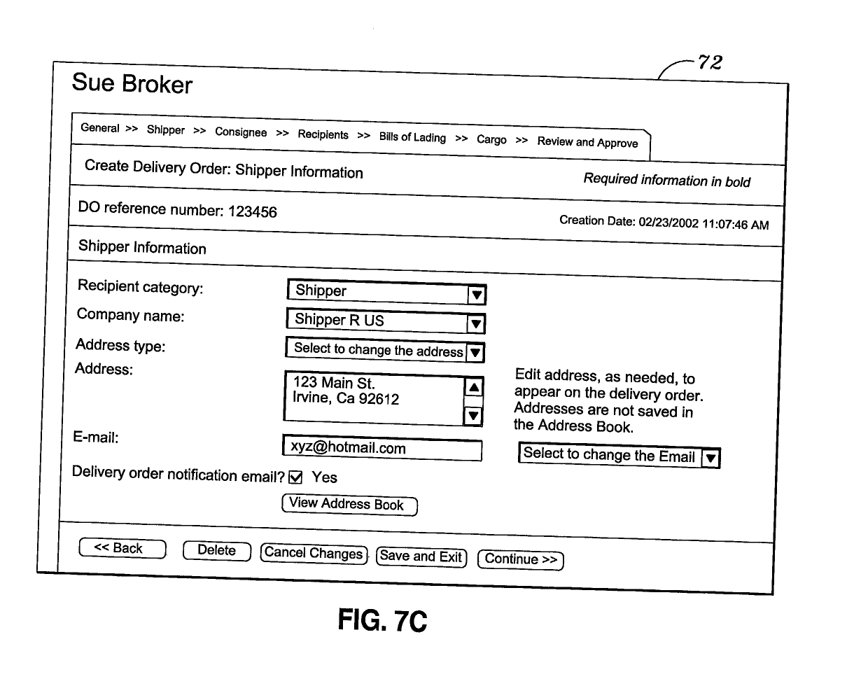

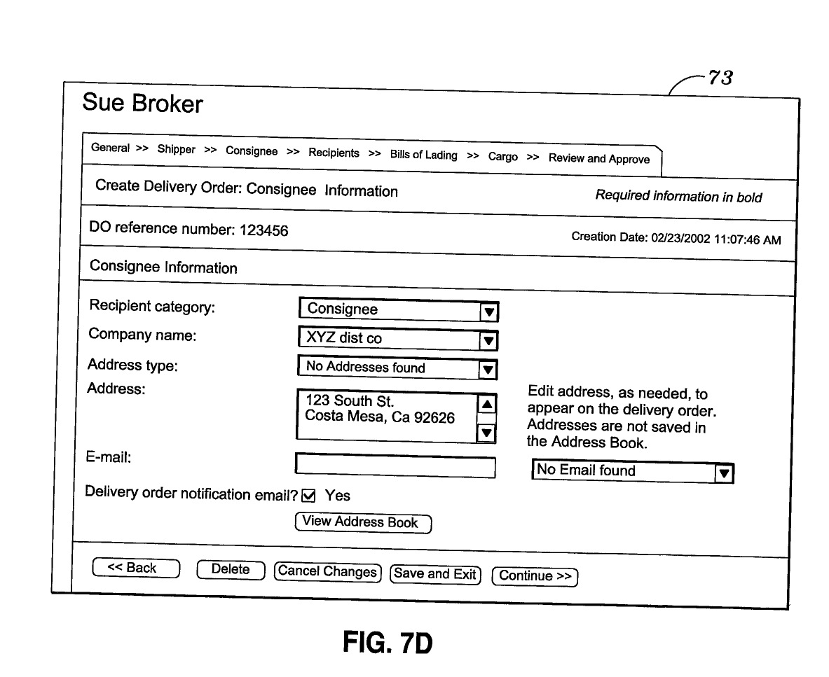

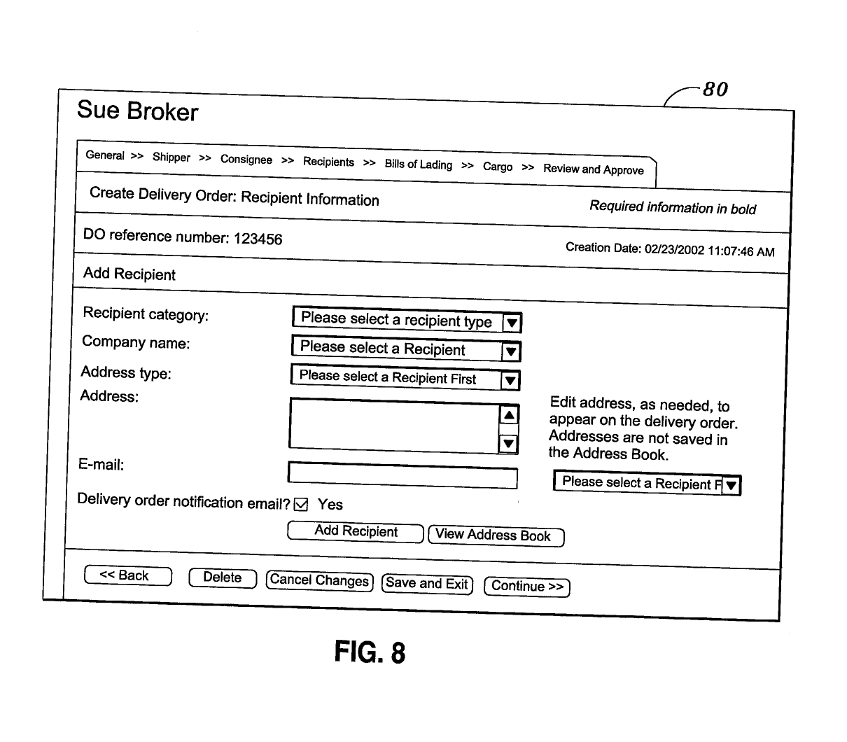

Although any one of the home pages can be displayed based on the user's ID and the eDO system accessed by different types of end user's as mentioned above, for the purposes of discussion, flow proceeds to step S601 in FIG. 6 in which from the broker's home page, which has been displayed in step S507, a broker selects to create a new delivery order in step S601. In providing the description of the process in the steps in FIG. 6, reference will also be made to the graphical user interfaces illustrated in FIGS. 7A-7D and FIG. 8.

Referring to step S507, upon identifying the user as a broker, a specific broker home page 70 for a particular broker is displayed based on the user's ID as shown in FIG. 7A. In step S601 in FIG. 6, the broker can select to “Create A New Delivery Order” as shown in FIG. 7A. Upon selecting “Create A Delivery Order” and by clicking on the “Go” button, the eDO system displays a “Create Delivery Order: General Information” window 71 in which general information regarding the delivery order can be input by the broker. For example, as shown in FIG. 7B, the broker can enter a specific delivery order reference number which is generated by the broker. Thereafter, using the information regarding the cargo either from bill of lading (B/L) or from other documentation provided by the shipper, the broker begins entering information required for creating a delivery order. This cargo information can include port of origin, vessel name, voyage/flight number, arrival date at the seaport/airport, and ocean/airline carrier. In addition to the above-noted information, the eDO system can prompt the broker for “last free day” information which indicates to a trucking company or the like what day the cargo can remain at the seaport/airport without a fee. In addition, the eDO system requires the broker to enter a trucking company's name which is to deliver the cargo. This information is used by the eDO system to notify the trucking company that a new delivery order has been sent to them. In this regard, address information of all recipients such as shipper, consignee, cargo carrier, trucking company, etc., is kept in the broker's address book database stored either locally on the broker's PC system and accessed by the eDO system or is stored directly in the eDO system's database and is retrieved when needed by the eDO system. The address information can be created at the time the broker initially uses the eDO system.

In step S603, a broker inputs the required information and can either continue the process or save and exit the system in step S604. Assuming that the broker continues with the process in step S606, the eDO system displays the “Shipper Information” window 72 into which the broker can input the shipper's information so that a notification can be sent to the shipper by the eDO system when the eDO system is informed by the trucking company that the cargo has been picked up and/or delivered. In step S607, the broker inputs the shipper's information and, if desired, in step S609, the broker can save and exit the system.

Assuming that the broker continues entering the delivery order information, flow proceeds to step S610 in which the eDO system displays the “Consignee Information” window 73 into which the consignee's information can be input. The consignee's information, as well as the shipper's information, is utilized by the eDO system, not only for notification purposes, but also to create a delivery order which is forwarded to the trucking company as well as the seaport/airport and cargo carrier. In addition, information gathered by each of the windows noted in FIGS. 7B, 7C and 7D is collected and provided in a single delivery order which will be discussed below. Upon inserting the consignee's information in step S611, the broker can save and exit in step S612.

The broker can enter information regarding additional recipients that should receive electronic notification or e-mail notification of pickup and delivery of cargo. As shown in FIG. 8, the eDO system displays a “Recipient Information” window 80 into which the broker can input recipient information which will be utilized for transmitting e-mail notifications of pickup and delivery. The eDO system provides for multiple recipients which can be added to the delivery order by the broker clicking on the “Add Recipient” button in the Recipient Information window in step S615. Once all the information has been added into the Recipient Information window, the broker can save and exit the system in step S616.

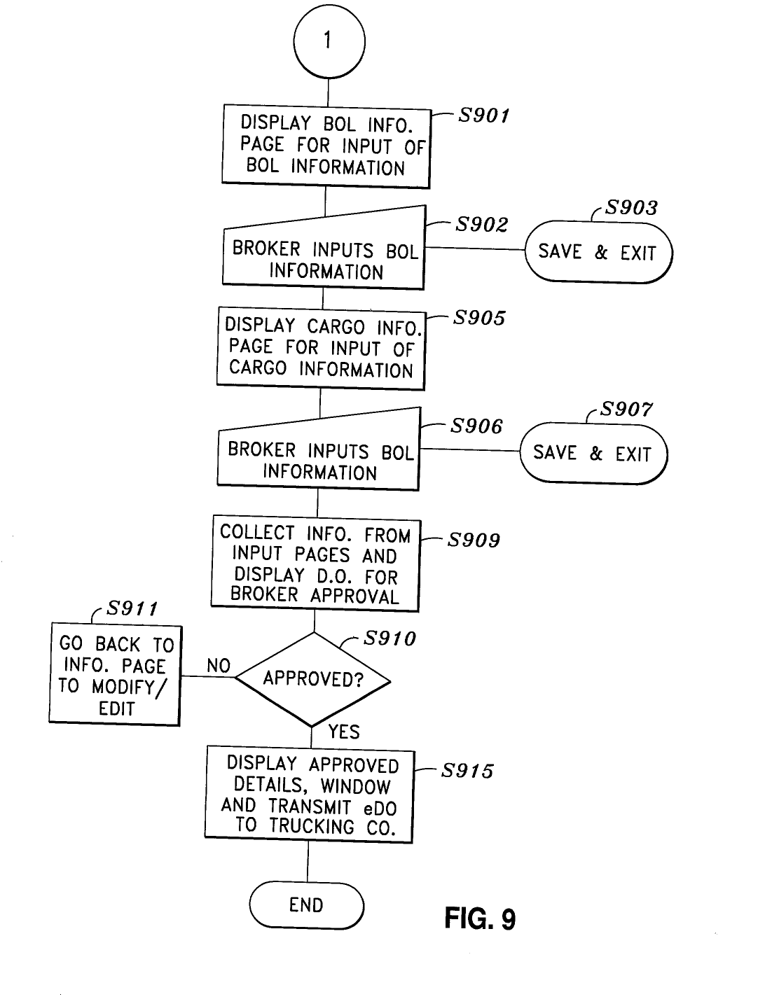

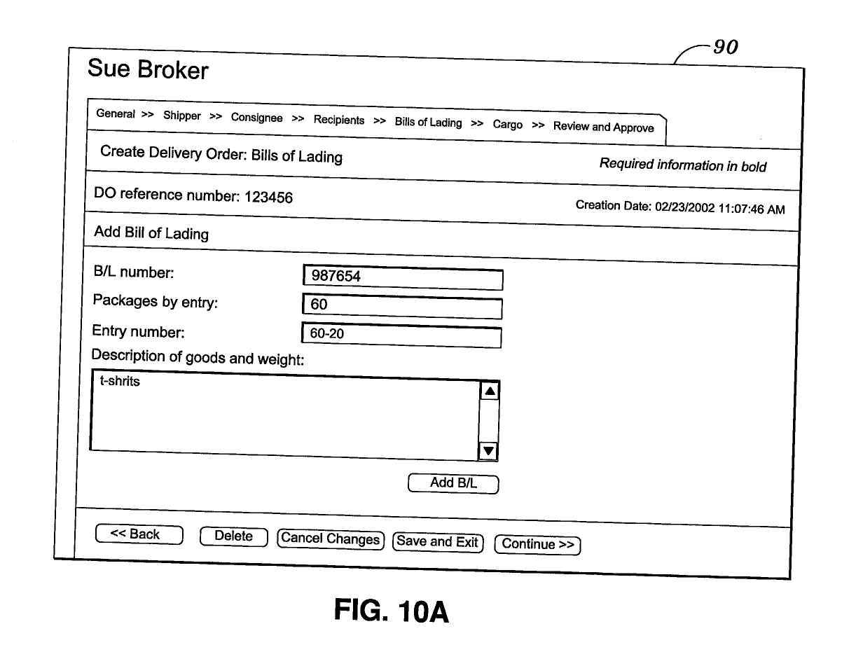

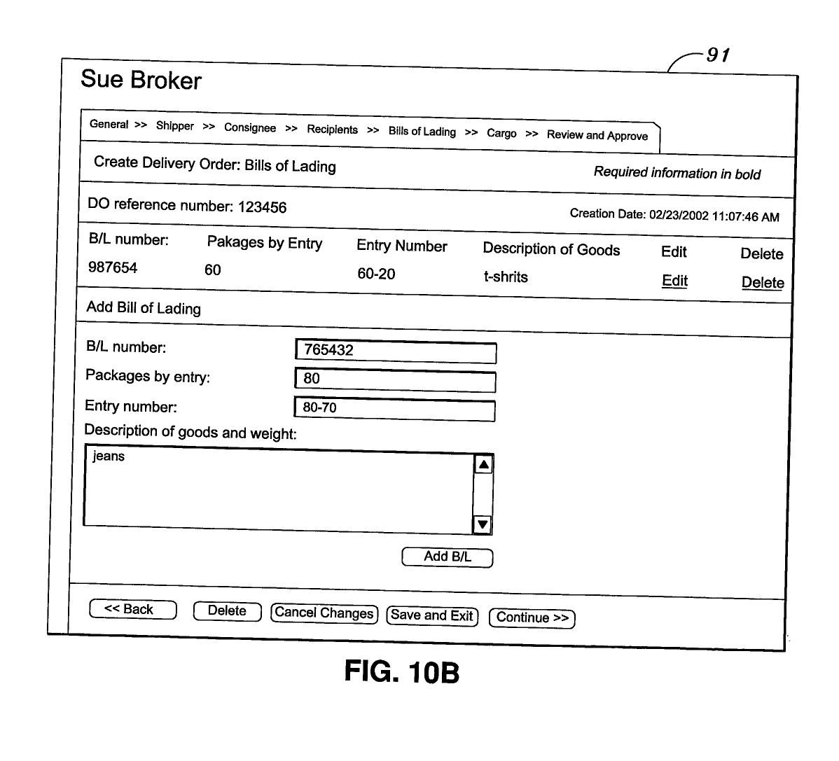

When all general information regarding the delivery order, shipper information, consignee information and recipient information are input, the eDO 7 system prompts the broker for information regarding the bill of lading (B/L) for the cargo. The process steps for inputting B/L information will be explained with reference to the flow diagram in FIG. 9 and the graphical user interfaces illustrated in FIG. 10.

Thus, in step S901 in FIG. 9, a “Bills Of Lading” information window 90 is displayed to the broker as shown in FIG. 10. In the Bills Of Lading window 90, the broker can input, for example, the bill of lading number, number of packages in the cargo, an entry number as well as a description of the goods and weight. In the case that there are multiple bills of lading for one delivery order, the broker can click on the “Add B/L” button in the Bill Of Lading window 90 in FIG. 10. Upon clicking on the Add B/L button in Bill Of Lading window 90, a second window 91, which includes summarized information regarding the first bill of lading entry, provides the broker with another input field for inputting the next bill of lading input number, number of packages, entry number of description of goods and weight. After the broker inputs the bill of lading information in step S902, the broker can save and exit the system in step S903.

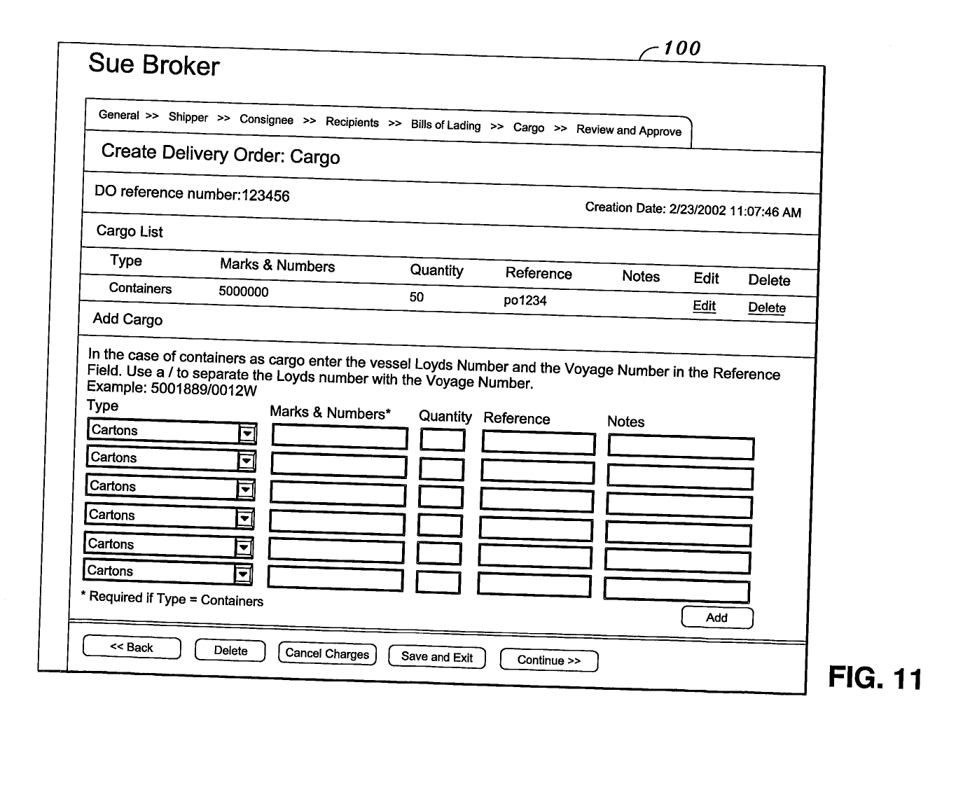

At this point, the broker may continue entering information for the delivery order by proceeding to step S905 in which the eDO system displays a “Cargo” window as shown in FIG. 11. As shown in FIG. 11, the Cargo window 100 permits the broker to enter the type of cargo whether it be cartons, containers, packages, etc., any marks and numbers which are indicated on the cargo, the quantity of cartons, containers, packages, etc., any reference numbers which may be associated with cargo, such as a purchase order provided by the shipper and any notes regarding the cargo. In this regard, the broker can enter at any time comments into certain fields of each of the information windows that may be helpful to the trucking company, terminal, consignee, shipper or cargo carrier since the completed delivery order will be transmitted for viewing by each of the participants in the transportation of the cargo. After entering the cargo information in step S906, the broker may save and exit the system in step S907.

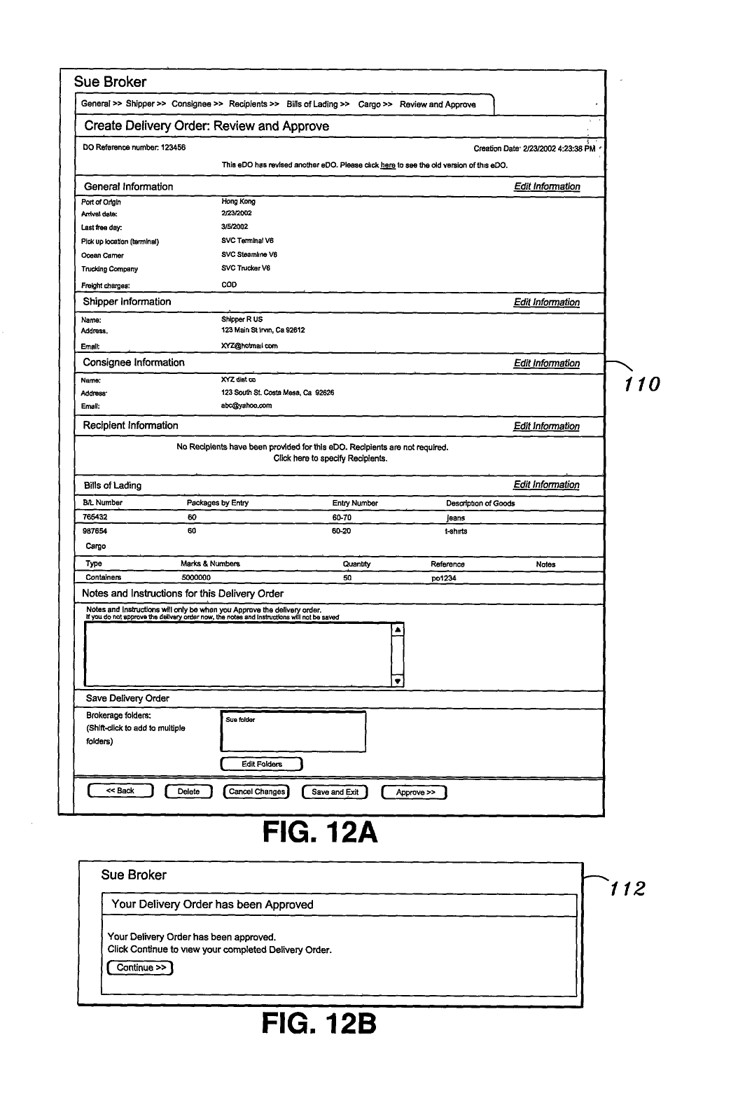

The broker can continue entering information regarding the delivery order by clicking on the “Continue” button in the Cargo window 100 as shown in FIG. 10. Upon clicking on the “Continue” button, the eDO system collects all information from each window and each input data field in each window in step S909. The eDO system displays a “Review And Approve” window 110 which shows a completed delivery order for the broker's approval as shown in FIG. 11. In step S910, the broker can review, edit or approve the delivery order as shown in FIG. 11. If the broker determines that some of the information in the delivery order needs to be edited, the broker may click on the “edit information” button in each category of input information, such as shipper information, consignee information, recipient information, bills of lading, and cargo in step S911. Should the broker select “edit information”, the broker will be returned to the specific input information window to edit the information therein. However, should the broker approve of the delivery order in step S910 by clicking on the “Approve” button at the bottom of the Review And Approve Delivery Order window 110 shown in FIG. 12A. Window 112 shown in FIG. 12B will be displayed confirming that the delivery order has been approved.

Simultaneously with approval of the delivery order, the eDO system acknowledges the approval and generates an e-mail notification which is transmitted to the designated trucking company which was input in the window illustrated in FIG. 7B. Therefore, in step S915, the confirmation of the approved delivery order is displayed and an e-mail notification is sent to the trucking company. At this point, the broker has entered all of the necessary information to schedule a delivery of the cargo. The broker will only be requested to enter additional information should the designated trucking company decline the request to deliver the cargo or if a predetermined amount of time has elapsed after the delivery order has been sent to the trucking company without a response. In this case, the eDO system will maintain a delivery order notification clock in order to track the time from delivery of the notification to the trucking company and compare the elapsed time with a preset time permitted by the broker for response. These features will be discussed below in more detail.

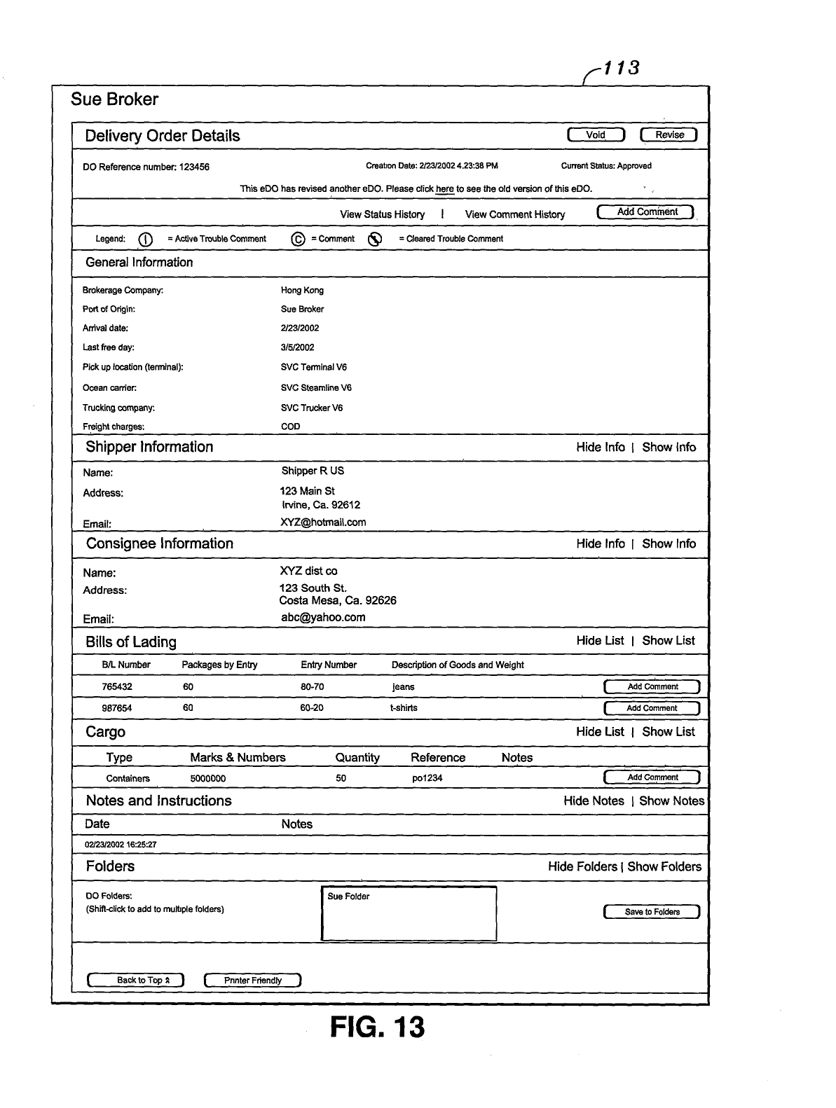

After window 112 is displayed confirming the delivery order, the broker clicks on the “continue” button and the eDO system produces and displays the finalized “Delivery Order Details” window 113 as shown in FIG. 13. Once the delivery order has been approved by the broker, the delivery order is stored in electronic format in the eDO system server and can be accessed by the broker for further editing at any time.

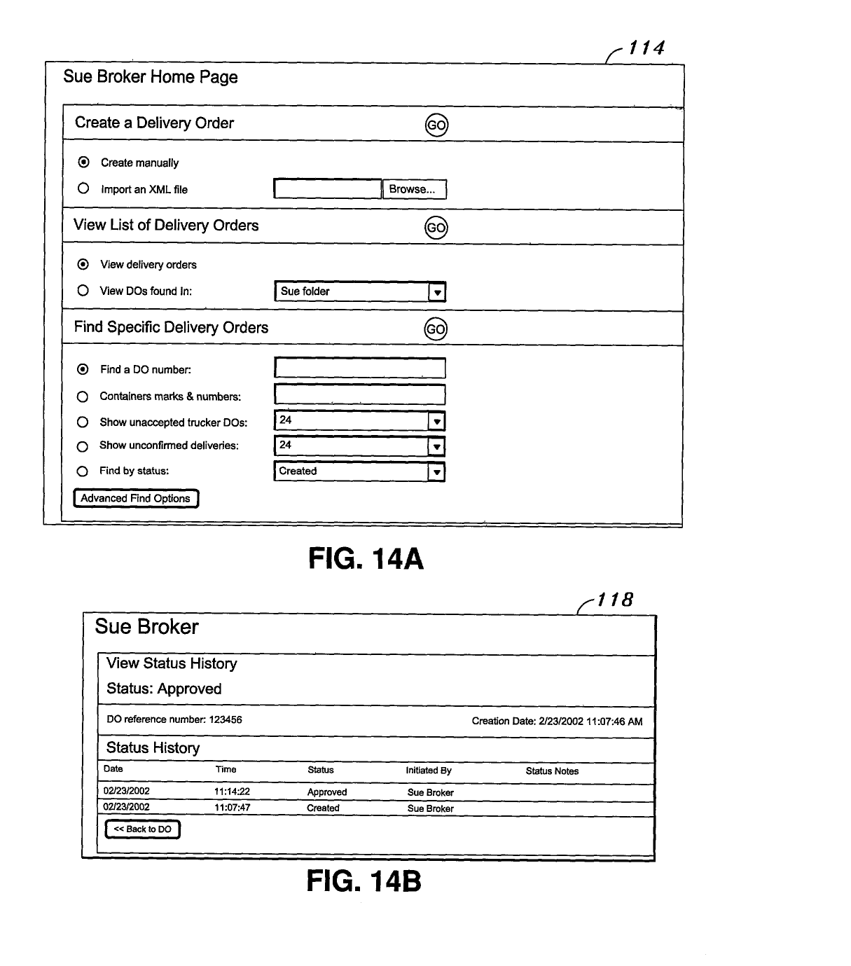

At any time during or after creation of the delivery order, the broker can access its home page 114 in order to view a list of created and approved delivery orders and/or to find specific delivery orders based on a delivery order number which has been assigned by the broker at the outset of creating the delivery order, the container number, or based on the status of the delivery order as shown in FIG. 14A. Using the “View Status History” window 118 shown in FIG. 14B, the broker can find the status of a delivery for all delivery orders. In the example shown in FIG. 14B, a status history of the delivery order with reference number “123456” indicates that it was created on Feb. 23, 2002 at 11:07 a.m. and was approved by the broker at 11:14 a.m. Since the delivery order has not been accepted by the trucking company, there is no indication in this history that it has been accepted. In addition, the status history would show that a specific delivery order has been delivered in the case the trucking company has delivered the order. As indicated by FIG. 14A, the broker's home page provides other various functionality which permits the broker to access information regarding all delivery orders or a specific delivery order, as well as being able to create a delivery order. As such, the system is very robust in providing functionality and information to the broker which was not provided in conventional delivery scheduling.

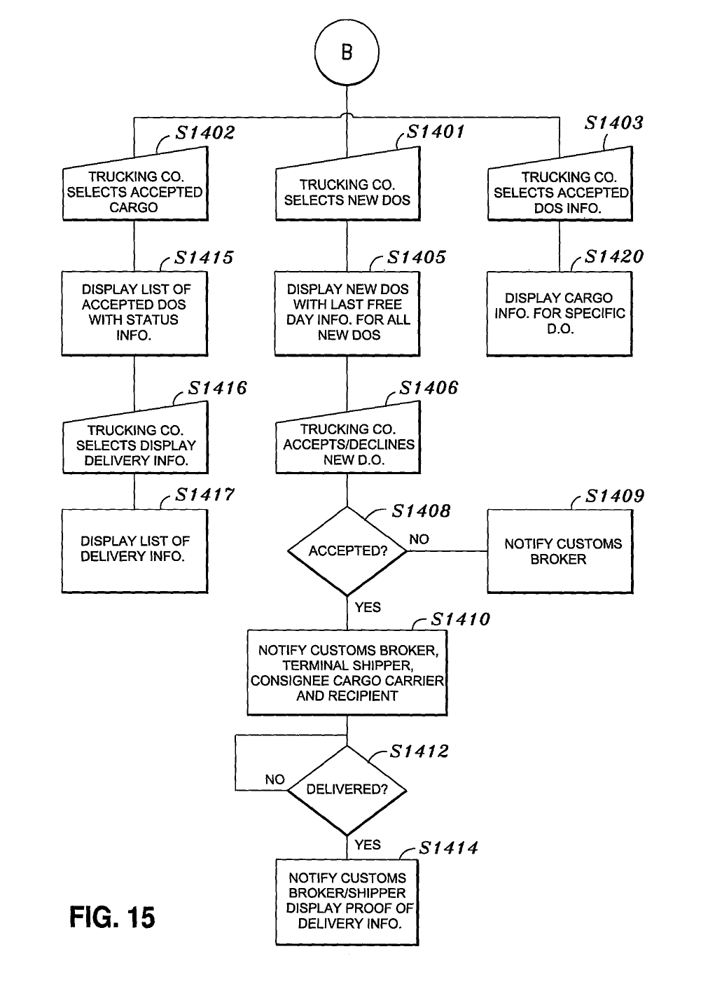

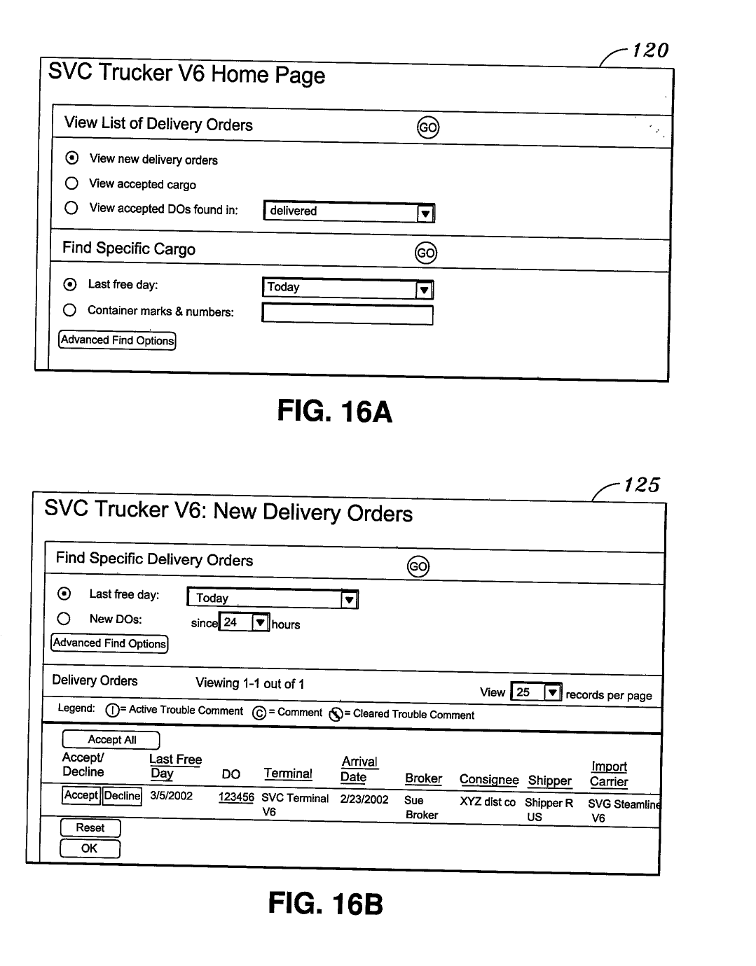

Once a delivery order has been approved, the trucking company receives an e-mail notification that a new delivery order is pending for acceptance at the trucking company's PC terminal. To obtain information regarding the new delivery order, the trucking company is required to sign onto the eDO system by launching the eDO program resident at the trucking company's PC. The steps for obtaining access to the eDO system is very similar to the process described with respect to the steps in the flow diagram illustrated in FIG. 5. For the purpose of brevity, those steps will not be repeated again. Once the eDO system has authorized access to the eDO system and has determined the user's ID based on the certification information, the specific trucking company's home page is displayed in step S507 in FIG. 5. From its home page, the trucking company can select multiple functionalities which are provided to the trucking company as shown in FIG. 16A. The process steps for reviewing new and accepted delivery order details will be explained in conjunction with the flow diagram in FIG. 15 and the graphical user interface illustrated in FIGS. 16A, 16B and 17-20.

In the present example, if the trucking company wants to view new delivery orders based on the e-mail notification received at the trucking company's personal computer, in step S1401 in FIG. 15, the trucking company selects a “View New Delivery Orders” and clicks on the “Go” button within the trucking company's home page 120 shown in FIG. 16A. Based on this selection, the eDO system displays “New Delivery Orders” window 125 as shown in FIG. 16B in which all new delivery orders which are assigned to “SVC Trucking” are shown in step S1405. From New Delivery Order window 125, the trucking company can accept or decline the delivery order.

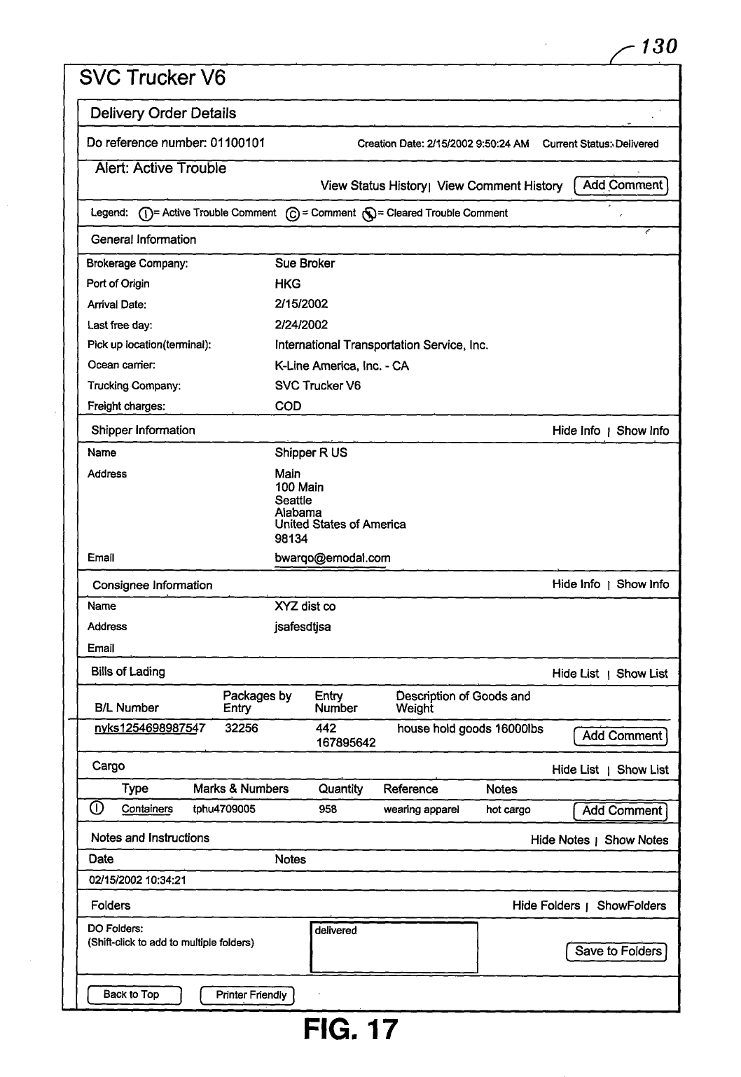

Prior to accepting or declining the delivery order, in step S1406, the trucking company can review details of the delivery order by selecting the delivery order number in New Delivery Order window 125 shown in FIG. 16B. Upon clicking on the delivery order number, the delivery order with status history will be displayed, as shown in FIG. 17. As shown in FIG. 17, the “Delivery Order Details” window 130 displays status history of the specific delivery order number to the trucking company. All of the information which has been input by the broker is displayed to the trucking company in a read-only format. The Delivery Order Details window 130 permits the trucking company only to enter comments in a comments field relating to, for example, the delivery order, the bill of lading, or the cargo. The comments are added to the delivery order and can be displayed to all participants who can view the delivery order, such as the customs broker terminal and cargo carrier. Each and all of the windows that are displayed throughout the electronic delivery order system can be printed out for a hard copy and, specifically, the delivery order details can be printed out and maintained by the trucking company.

The New Delivery Orders window 125 shown in FIG. 16B also provides the trucking company with information regarding the “last free day” in which the cargo will remain at a seaport/airport without a fee. The New Delivery Orders window 125 also includes the new delivery order number, the terminal from where the cargo can be picked up, the date on which the cargo arrived at the terminal, the broker who is requesting the delivery, the consignee who is to receive the delivery, the shipper who sent the cargo and the cargo carrier that has delivered the cargo to the terminal/port. Most importantly, the New Delivery Orders window 125 includes Accept/Decline buttons which permit the trucking company to either accept or decline the delivery order. In step S1406, the trucking company accepts/declines the delivery order(s) that are displayed in New Delivery Orders window shown in FIG. 16B.

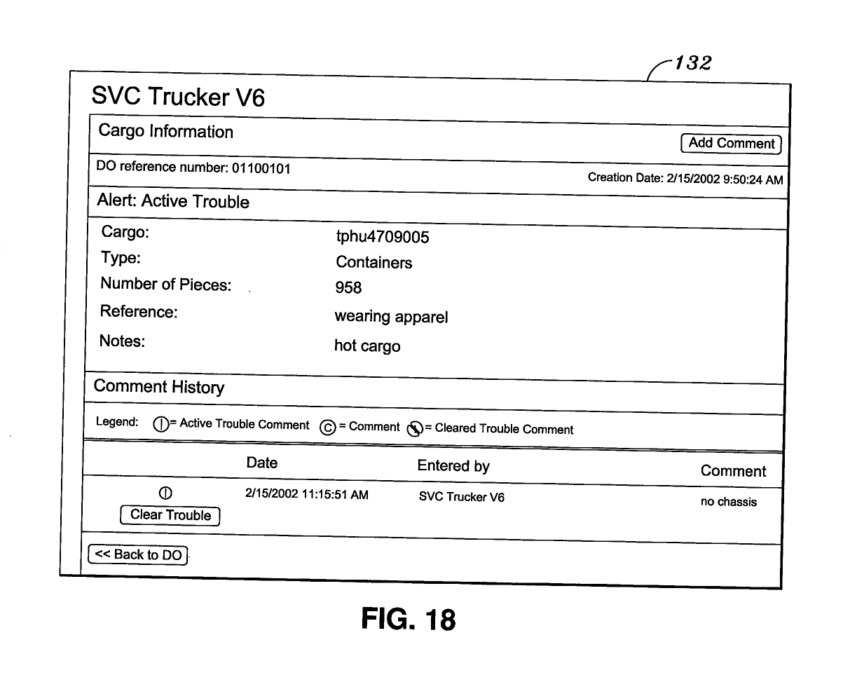

In reviewing the delivery order in step S1406 from the delivery order details window shown in FIG. 17, the trucking company can obtain additional information regarding the cargo by selecting what is listed under the “type” category. In the example shown in FIG. 17, upon clicking on the cargo-type indicated as “containers” and identified with marks and numbers “TPHU4709005” in Delivery Order window 130, “Cargo Information” window 132, shown in FIG. 18, will be displayed providing all the pertinent information regarding the cargo in the containers which are identified with marks and numbers “TPHU4709005”.

In step S1408, it is determined by the eDO system if a specific delivery order has been accepted or declined. If a delivery order has been declined in step S1408, an e-mail notification is sent to the broker, who sent the request to the trucking company, in step S1409, notifying the broker that the delivery has been declined by the designated trucking company. In this case, the broker can access its eDO home page and edit the delivery order by inputting a name of a different trucking company to which the delivery order should be sent. Upon editing the trucking company's name and after approval, the edited or new delivery order is sent out in the same fashion as described above to the newly designated trucking company for acceptance.

Referring to the flow in FIG. 15, if the delivery order has been accepted by the trucking company, flow proceeds to step S1410. In step S1410, the eDO system prepares and sends an e-mail notification of the acceptance of the delivery order by the trucking company to the broker, the terminal, the shipper, the consignee, the cargo carrier and other listed recipients. The e-mail notification can include the trucking company's name and the date of acceptance of the delivery order. This information is used by the recipients and, in particular, the terminal for security purposes.

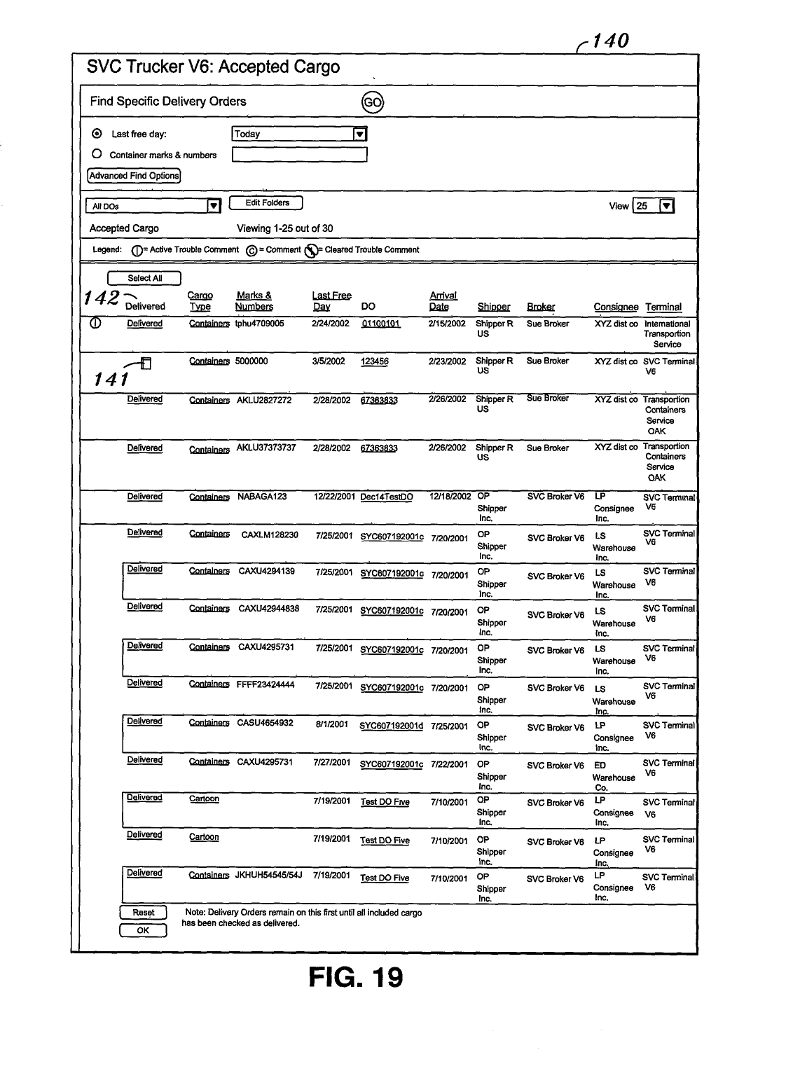

Reverting to flow diagram in FIG. 15, in step S1402, from the trucking company's home page 120, shown in FIG. 16A, the trucking company can select View Accepted Cargo. Upon selecting the “View Accepted Cargo” from the trucking company's home page 120, the eDO system displays “Accepted Cargo” window 140 for that specific trucking company as shown in FIG. 19. In FIG. 19, the Accepted Cargo window 140 provides pertinent information regarding the cargo and its status in step S1415. From the Accepted Cargo window 140 in FIG. 19, the trucking company can view all accepted cargo which includes delivered and undelivered cargo.

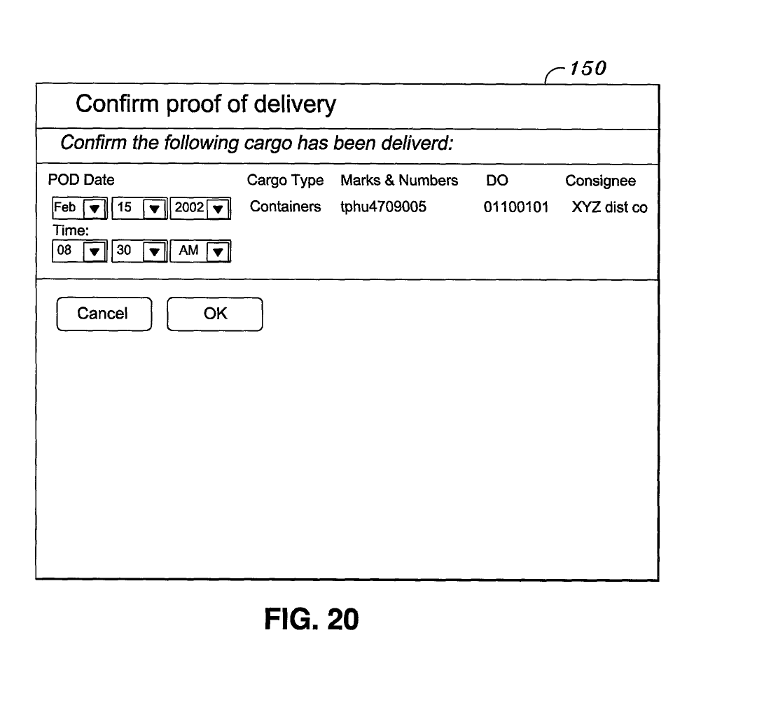

In the example shown in FIG. 19, the delivery order indicated with delivery order number 01100101 has been delivered. Upon clicking on “Delivered” under the “Delivered” category 142 in step S1416, a “Confirm Proof Of Delivery” window 150 will appear as shown in FIG. 20. In that window, the trucking company can view, in step S1417, the time and date that specific cargo has been delivered.

Reverting to the flow in FIG. 15 in step S1403, the trucking company selects “Accepted Delivery Orders” from its home page and the eDO system displays an Accepted Cargo window 140 which includes a list of accepted delivery orders with status information in step S1420. From this window, the trucking company can also obtain delivery information which is under the “Delivered” information category. For each delivery order, the eDO system has stored information regarding the delivery status of that specific delivery order. For example, as shown in FIG. 19, delivery order 01100101, identified with marks and numbers “TPHU4709005”, has arrived at the terminal on Feb. 15, 2002.

Once the trucking company has accepted the delivery, the trucking company utilizes the delivery order information to pick up the cargo at the designated seaport/airport. Since the terminal will have similar information regarding the delivery order specifics as well as the trucking company, the terminal will be prepared to receive the trucking company at its seaport/airport. Upon picking up the cargo at the terminal and delivering the cargo to the consignee specified in the delivery order, the trucking company can sign back onto the eDO system as discussed previously with respect to FIG. 5 and, from the trucking company's home page shown in FIG. 16A, can click on the view “Accepted DOs” button in order to be directed to the “Accepted Cargo” window shown in FIG. 19.

Referring to the flow diagram in FIG. 15, from the Accepted Cargo window 140, the trucking company can locate the specific cargo based on the delivery order number and under the “Delivered” category 142 in the window shown in FIG. 19, there is box 141 which can be checked by the trucking company to indicate that the cargo has been delivered in step S1412. Upon checking box 141 in the example shown in FIG. 19 for delivery order 123456, the delivery order will be updated in the eDO system and e-mail notification will be sent out to all participants such as the customs broker, the shipper, terminal and cargo carrier in step S1414.

Although the broker and the trucking company are the two main participants in the transportation and delivery of cargo, the eDO system can also be used to deliver an accepted delivery order and delivered cargo to the shipper, terminal and cargo carrier. In this regard, upon acceptance of a delivery order by the trucking company, the terminal and cargo carrier are provided with e-mail notification that a delivery order has been accepted for delivery. The cargo carrier utilizes this information to identify the trucking company which is moving its container or rented container and on what date it would be moved so that it can collect a “per diem” charge if the container is not returned to the cargo carrier within a predetermined time period.

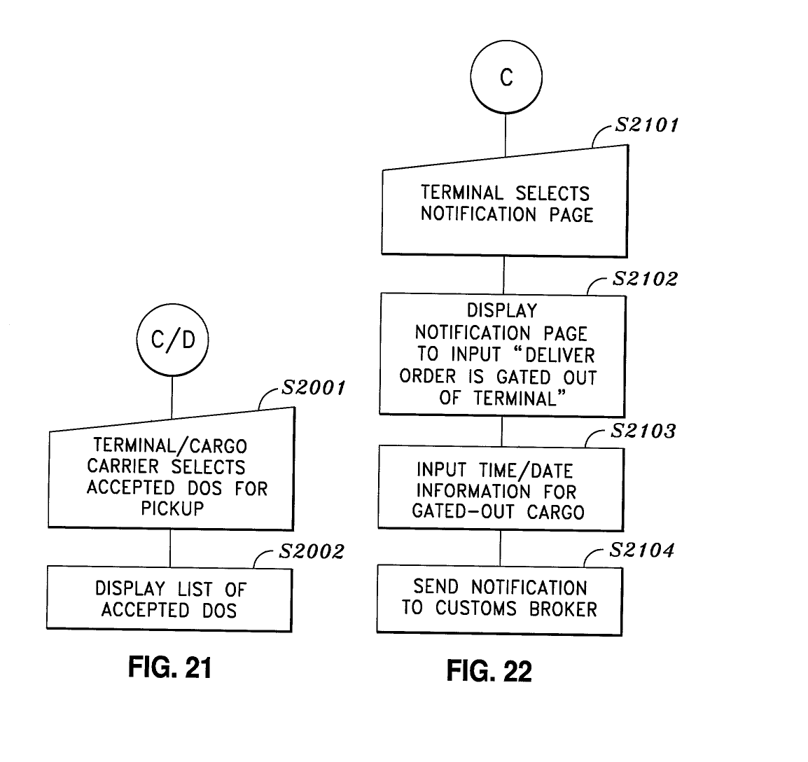

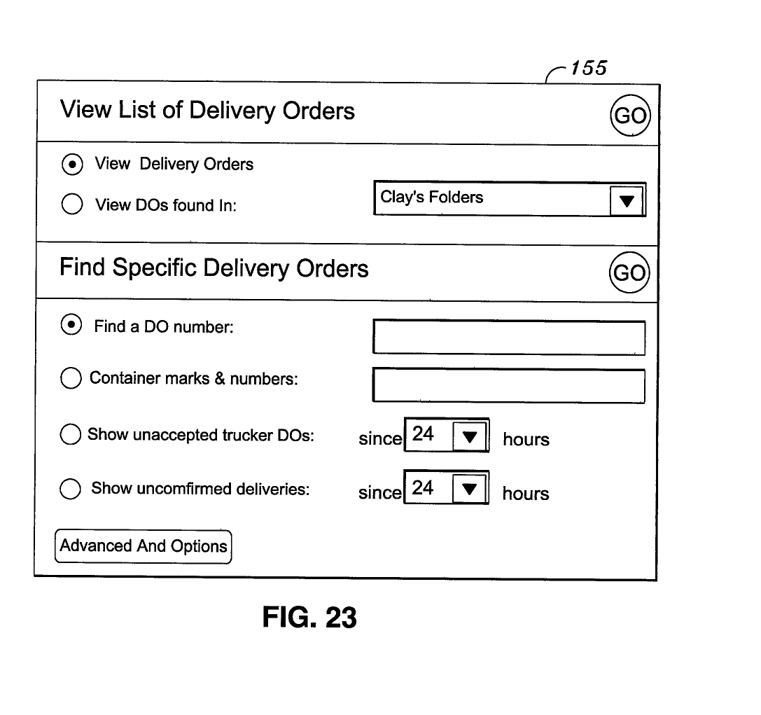

For the terminal, the notification and delivery order provides information regarding the cargo to be picked up as well as providing information regarding which trucking company is to pick up the cargo at its terminal. This feature provides a layer of security for the terminal in order to prevent cargo from leaving the terminal with the wrong trucking company or party. Moreover, the information on the delivery order will permit the seaport/airport to locate the cargo for shipping and move it to an area for pickup. This provides an advantage to the terminal which can locate cargo for pickup and an advantage to the trucking company which can schedule drivers to be sent to the terminal and prevents delays in obtaining access to the terminal and the cargo. The process steps for a terminal/cargo carrier to view the status history of delivery orders will be discussed with respect to the flow diagrams in FIGS. 21 and 22 and the graphical user interface in FIG. 23.

Thus, in FIG. 21, upon receiving e-mail notification that a delivery order has been accepted by the trucking company for delivery, the terminal/cargo carrier can access the eDO system as described in FIG. 5. Upon receiving authorization to utilize the system, the eDO system displays the terminal/cargo carrier with its home page so that it can review delivery orders and delivery order status. Thus, as described in the flow diagram in FIG. 21 in step S2001, the terminal/cargo carrier can access delivery orders from the terminal/cargo carrier's home page 155 shown in FIG. 23. Upon selecting the “View Delivery Orders” from home page 155 in FIG. 23, the eDO system displays a list of accepted delivery orders with status information for each delivery order displayed. In this regard, the eDO system displays “Accepted Cargo” window 140 similar to that shown in FIG. 19, however, it is displayed with the appropriate terminal/cargo carrier's name. The information provided in the Accepted Cargo window 140 is read-only format. The terminal/cargo carrier can review all the pertinent information regarding each delivery order much like the trucking company has access to the pertinent information regarding every delivery order.

In addition to having the ability to review a list of accepted delivery orders with its pertinent information, the terminal's home page has the capability of sending out a notification in the form of an e-mail notification indicating that a specific piece of cargo in a given delivery order has left the terminal.

As described in the flow diagram illustrated in FIG. 22, in step S2101, the terminal selects “Notification” from its home page. Upon clicking on the “Notification” button on its home page, the eDO system displays in step S2102 a Notification window. In the Notification window, the terminal enters time/date information for a specific delivery order which has been picked up from the terminal in step S2103. After entering the time/date information relating to when cargo was gated out of the terminal, a notification is sent out to the broker in step S2104 informing the broker when a specific delivery order has gated out of the terminal. This notification can also be sent to the cargo carrier so that the cargo carrier can begin calculating the amount of days a cargo container is with a trucking company so that it can be reimbursed on a “per diem” basis for the container should it not be returned within a predetermined number of days. A notification can also be sent to other recipients that may have an interest as to when the cargo has left the terminal. In this regard, this information can also be sent to the shipper, consignee and others that are participants in the transportation of the cargo.

Although the present invention has been described as a web-based system, the present invention can also be integrated directly into the broker's PC or server. In this fashion, only the broker has access to the eDO system and no other brokers outside of the broker's company can access the personalized integrated system. The integrated system would act much in the same way as the web-based system, although only the broker onto which the eDO system is integrated will have access to its integrated system.

Although the eDO system explained above required manual input by the broker of information regarding the cargo and delivery order, this information could also be automatically input into the eDO system by transmitting an electronic file to the eDO system which would input the data into appropriate data fields of the eDO system of the delivery scheduling windows.

In an alternative embodiment, the shipper, consignee and recipient data input windows may be collapsed into or replaced by an eDO “Third Party” data input window into which the customs broker can input address and name information directly or import address and name information from the customs broker's address book for all third parties that should receive notification regarding the delivery status of an item. Since the shipper, consignee and other recipients of notification do not have access to the eDO system, the shipper, consignee and recipient data input windows can be simplified to one or more “Third Party” data input windows. The information from the “Third Party” input window(s) will be used by the eDO system to complete the delivery order with pertinent information and to notify the third parties of delivery status.

While the present invention has been discussed with respect to what is presently considered to be the preferred embodiment, it is to be understood that the invention is not limited to the disclosed embodiment. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for scheduling a delivery and for providing delivery status notification, the method comprising the steps of:
accessing a scheduling and notification database;
inputting delivery data into the scheduling and notification database relating to an item to be delivered;
collecting delivery data into a delivery order;
transmitting the delivery order relating to the item to be delivered together with a delivery request;
receiving an acceptance or a decline of the delivery request; and
providing notification of either acceptance or a decline of the delivery request.

2. A method for scheduling a delivery and for providing delivery status notification according to claim 1, further comprising the steps of receiving confirmation of delivery and providing notification of the confirmation of delivery.

3. A method for scheduling a delivery and for providing delivery status notification according to claim 1, further including the step of displaying at least one graphical user interface for inputting data relating to the item to be delivered, wherein the data includes item information and delivery information.

4. The method for scheduling a delivery and for providing delivery status notification according to claim 1, wherein, in the case the request for delivery is declined, the scheduling and notification database accepts revised delivery data from the end user, collects the revised delivery data and transmits the revised delivery data and a request for delivery.

5. The method for scheduling a delivery and for providing delivery status notification according to claim 1, wherein, in the accessing step, certification data is transmitted to the scheduling and notification database to acquire access to the scheduling and notification database.

6. The method for scheduling a delivery and for providing delivery status notification according to claim 1, wherein, in the collecting step, delivery data is collected into an electronically formatted delivery order and, in the transmitting step, the electronically formatted delivery order, together with a request for delivery, is transmitted electronically in order to schedule a delivery.

7. The method for scheduling a delivery and for providing delivery status notification according to claim 1, wherein when the delivery of the item is complete, confirmation of the delivery of the item is received by the scheduling and notification database and wherein the scheduling the notification database automatically provides notification that the item is delivered.

8. The method for scheduling a delivery and for providing delivery status notification according to claim 1, wherein, in the accessing step, the scheduling and delivery database determines if access is to be granted and, if granted, whether or not access is read-only access or read/write access.

9. The method for scheduling a delivery and for providing delivery status notification according to claim 1, further comprising the step of reviewing the collected delivery data and revising, if necessary, before performing the transmitting step.

10. A delivery schedule and notification system, comprising:
input means for inputting data relating to an item to be delivered and delivery information;
collecting means for collecting and storing input data relating to the delivery of the item; and
transmitting means for transmitting the collected input data so as to schedule delivery of the item.

11. Computer executable process steps stored on a computer readable medium, said computer executable process steps for scheduling a delivery and for providing delivery status notification, the process comprising the steps of:
an access step for accessing a scheduling and notification database;
an input step for inputting delivery data into the scheduling and notification database relating to an item to be delivered;
a collecting step for collecting delivery data into a formatted delivery order;
a transmitting step for transmitting the delivery order relating to the item to be delivered together with a delivery request;
a receiving step for receiving an acceptance or a decline of the delivery request; and
a providing step for providing notification of either acceptance or a decline of the delivery request.

12. Computer executable process steps according to claim 11, further comprising the steps of:
a confirmation step for receiving confirmation of delivery; and
a notification step for providing notification of the confirmation of delivery.

13. Computer executable process steps according to claim 11, further including the step of displaying at least one graphical user interface for inputting data relating to the item to be delivered, wherein the data includes item information and delivery information.

14. Computer executable process steps according to claim 11, wherein, in the case the request for delivery is declined, the scheduling and notification database accepts revised delivery data from the end user, collects the revised delivery data and transmits the revised delivery data and a request for delivery.

15. Computer executable process steps according to claim 11, wherein, in the accessing step, certification data is transmitted to the scheduling and notification database to acquire access to the scheduling and notification database.

16. Computer executable process steps according to claim 11, wherein, in the collecting step, delivery data is collected into an electronically formatted delivery order and, in the transmitting step, the electronically formatted delivery order, together with a request for delivery, is transmitted electronically in order to schedule a delivery.

17. Computer executable process steps according to claim 11, wherein when the delivery of the item is complete, confirmation of the delivery of the item is received by the scheduling and notification database and wherein the scheduling the notification database automatically provides notification that the item is delivered.

18. Computer executable process steps according to claim 11, wherein, in the accessing step, the scheduling and delivery database determines if access is to be granted and, if granted, whether or not access is read only access.

19. Computer executable process steps according to claim 11, further comprising the step of reviewing the collected delivery data and revising, if necessary, before performing the transmitting step.

20. Computer executable process steps stored on a computer readable memory, said computer executable process steps for a delivery schedule and notification system, comprising the steps of:
an input step for inputting data relating to an item to be delivered and delivery information;
a collecting step for collecting and storing input data relating to the delivery of the item; and
a transmitting step for transmitting the collected input data so as to schedule delivery of the item.

21. An apparatus comprising:
a program memory for storing process steps executable to perform a method according to any one of claims 1 to 9; and
a processor for executing the process steps in said program memory.
